(19) United States
(12) Patent Application Publication
(10) Pub. No.: US 2006/0029716 A1
(43) Pub. Date: Feb. 9, 2006

(54) Device for shaping eggs for cooking in a microwave

(76) Inventor: Diane L. Harker, North Huntingdon, PA (US)

Correspondence Address: NILS H. LJUNGMAN;NILS H. LJUNGMAN & ASSOCIATES, P.O. BOX 130, GREENSBURG, PA, 15601-0130, US

(21) Appl. No.: 11/193,991

(22) Filed: Jul. 28, 2005

Related U.S. Application Data
(60) Provisional application No. 60/592,196, filed on Jul. 29, 2004.

(51) Int. Cl. A23L 1/32

(52) U.S. Cl. 426/614

(57) ABSTRACT

A device for cooking eggs in the microwave, which device may have the ability to shape the eggs to match the shapes of various types of bread. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### RELATED APPLICATION DATA

This application claims priority from U.S. Provisional Patent Application No. 60/592,196, filed Jul. 29, 2004.

### BACKGROUND

1. Technical Field

This application relates to a device that cooks eggs in the microwave to a desired shape for different bread types.

2. Background Information

Eggs are cooked everyday in homes and restaurants for various bread types. However, the exact shape of the egg for the desired bread, such as a squared loaf of bread, bagels, muffins, or croissants, may not be produced by conventional methods of either stove top or microwave cooking. In some cases, more than one shape is desired. Some stove top cooking tools exist to help form the eggs, but usually result in the misshaping of the egg. Consequently, cooking the egg in the shape of a desired type of bread may not be achieved.

The existing stove top tools for producing a desired shape of cooked eggs cannot be used in the microwave. Consequently, eggs may only be cooked in a desired shape on a griddle or in a pan, using a stove. Since people are more often in a hurry to cook their eggs so that they can get to work, feed their children before school, or just generally save valuable time, it is usually not convenient to have to cook an egg on the stove top and clean up the mess when they are finished. It would therefore be helpful and more convenient to cook eggs, which are a healthy part of a balanced diet, in the microwave. Parents would be more willing to feed their children something healthy for breakfast if it were easy and convenient to prepare. Further, if people could cook their eggs in the microwave in the shape of a desired type of bread, they could avoid any messes caused by eggs that are too large hanging off the side of the bread. Conversely, cooking eggs in the shape of a desired type of bread could avoid the problem of eggs that are too small for the bread, creating an undesirable sandwich.

### OBJECT OR OBJECTS

One possible object is to provide a device for cooking eggs in the microwave.

Another possible object is to provide a device for cooking eggs in the microwave, which device has the ability to shape the eggs to match the shapes of various types of bread.

### SUMMARY

The objects can be achieved in a device for cooking eggs in the microwave, which device may have the ability to shape the eggs to match the shapes of various types of bread, according to at least one embodiment of the present application.

The device could comprise a universal lid. The universal lid could be designed to fit any and all embodiments. The universal lid could be substantially square-shaped. The universal lid could further comprise a protruding handle on the top of the lid for safe and easy removal of the lid from the device for cooking eggs in the microwave. Further, the universal lid could comprise at least four ventilation holes near the protruding handle. Further, the universal lid could comprise a protruding lip around the edges on the bottom side of the lid, which protruding lip could be designed to connectedly fit with the edge of the square or bread-shaped device. The universal lid could further comprise a circular protrusion on the bottom side of the lid, which circular protrusion could be designed to connectedly fit with the edge of the bagel-shaped device. Further, the universal lid could comprise another circular protrusion on the bottom side of the lid, which circular protrusion could be designed to connectedly fit with the edge of the English muffin-shaped device. The universal lid may comprise any number of protrusions on the bottom side of the lid to connectedly fit with any other embodiments of the device for cooking eggs in the shape of other types of bread, such as a croissant, different types of rolls, or smaller types of square bread. The universal lid may further be completely removable from the device, or may be hingedly attached on one side of the device.

In one possible embodiment, the device for cooking eggs could be in the shape of an English muffin, that is, in the shape of a cylinder having the circumference of a typical English muffin sold in stores. The device could be constructed with any number of microwavable materials, such as plastic or ceramic. The device for cooking eggs in the microwave could be cup-like or bowl-like in that it could hold the contents of the raw egg therein for cooking. The egg could be prepared in any number of ways, including being mixed to make a scrambled egg, being cooked sunny-side or yolk up, or having other ingredients, such as vegetables, added to the egg. The device for cooking eggs could further comprise at least one handle for safely removing the device from the microwave without burning the user's hands.

To prepare the eggs, a user may first decide the type of egg desired to be cooked. A scrambled egg could be mixed in a separate bowl or container prior to cooking, and any other desired ingredients added to the egg. Alternatively, the egg may not be mixed, but rather cooked sunny-side up style. Once the mixture is ready for cooking, it could be poured into the device for cooking eggs in the microwave, and the universal lid could be placed on top of the device. The mixture could sit evenly within the device, and could be cooked in the microwave for the desired length of time. Once cooking is complete, the user could remove the device from the microwave using the handle on the side of the device so as not to burn the user's hands. The egg may be cooked evenly all the way through, and may be in the shape of an even circle of the appropriate circumference to fit an English muffin. The egg could then be placed on the English muffin. Since the egg may be a substantially perfect fit for the English muffin, there may be little to no mess incurred when eating the egg sandwich. The egg sandwich may therefore be eaten on the run to save time for the user.

In another possible embodiment, the device for cooking eggs could be in the shape of a bagel, that is, in the shape of a cylinder having the circumference of a typical bagel sold in stores, and having a cylindrical protrusion in the center of the device to create a hole in the center of the cooked egg. The device could be constructed with any number of microwavable materials, such as plastic or ceramic. The device for cooking eggs in the microwave could be cup-like or bowl-like in that it could hold the contents of the raw egg therein for cooking. The egg could be prepared in any number of ways, including being mixed to make a scrambled egg, being cooked sunny-side or yolk up, or having other ingredients, such as vegetables, added to the egg. The device for cooking eggs could further comprise at least one handle for safely removing the device from the microwave without burning the user's hands.

To prepare the eggs, a user may first decide the type of egg desired to be cooked. A scrambled egg could be mixed in a separate bowl or container prior to cooking, and any other desired ingredients added to the mixture. Once the mixture is ready for cooking, it could be poured into the device for cooking eggs in the microwave, and the universal lid could be placed on top of the device. The mixture could sit evenly within the device, and could be cooked in the microwave for the desired length of time. Once cooking is complete, the user could remove the device from the microwave using the handle on the side of the device so as not to burn the user's hands. The egg may be cooked evenly all the way through, and may be in the shape of an even circle of the appropriate circumference to fit a bagel. The egg could further comprise a hole in the center, which hole could have been created by the cylindrical protrusion in the center of the device. The egg could then be placed on the bagel. Since the egg may be a substantially perfect fit for the bagel, including the void in the center of the egg to match the hole on the bagel, there may be little to no mess incurred when eating the egg sandwich. The egg sandwich may therefore be eaten on the run to save time for the user.

In yet another possible embodiment, the device for cooking eggs could be in the shape of a square piece of bread, that is, in the shape of a square having the length and width of a typical piece of bread sold in a loaf in stores. The device could be constructed with any number of microwavable materials, such as plastic or ceramic. The device for cooking eggs in the microwave could be cup-like or bowl-like in that it could hold the contents of the raw egg therein for cooking. In another possible embodiment, the device may not comprise a lid. The egg could be cooked in the microwave without a lid or covering atop the device. Alternatively, a napkin, paper towel, plate, saucer, paper plate, towel, or any number of microwavable materials may be used to cover the device. The egg could be prepared in any number of ways, including being mixed to make a scrambled egg, being cooked sunny-side or yolk up, or having other ingredients, such as vegetables, added to the egg. The device for cooking eggs could further comprise at least one handle for safely removing the device from the microwave without burning the user's hands.

To prepare the eggs, a user may first decide the type of egg desired to be cooked. A scrambled egg could be mixed in a separate bowl or container prior to cooking, and any other desired ingredients added to the mixture. Once the mixture is ready for cooking, it could be poured into the device for cooking eggs in the microwave, and the universal lid could be placed on top of the device. The user may experiment with microwave power and cooking times in order to cook the egg to the desired doneness. In order to cook the egg evenly, it may be preferable for the user to set the microwave to a lower power, for example, approximately 20-30% power. The length of time the egg may be cooked in the microwave may differ between different types of microwaves. The user may find a preferable amount of power and time to cook the egg in order for the egg to cook evenly, and not to be rubbery or hard in some spots, and undercooked in other spots.

Once added to the device, the egg may sit evenly within the device, and could be cooked in the microwave for the desired length of time. Once cooking is complete, the user could remove the device from the microwave using the handle on the side of the device so as not to burn the user's hands. The egg may be cooked evenly all the way through, and may be in the shape of a square with the appropriate length and width to match a typical piece of bread sold in a loaf in stores. The egg could then be placed on the bread. Since the egg may be a substantially perfect fit for the bread, there may be little to no mess incurred when eating the egg sandwich. The egg sandwich may therefore be eaten on the run to save time for the user.

The device for cooking eggs in the microwave could have any number of shapes for any number of types of bread. For example, the device could be in the shape of a croissant, an oval or rectangular type of sandwich roll, smaller types of square bread, or any type of baked good. The device may be shaped such that it could mimic the shape of any such baked good, so as to shape the egg such that it neither hangs off the sides of the baked good, nor is too small for the baked good. Further, the universal lid could comprise a protrusion to connectedly fit the device with any of these shapes. The device for cooking eggs may also be constructed with a material such as metal, and may be used on the stove top or griddle for cooking eggs.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to the accompanying drawings.

FIG. 1 is a side view of the first embodiment;

FIG. 1A is a top view of the first embodiment;

FIG. 1B is a side view of the first embodiment;

FIG. 1C is a top view of the first embodiment;

FIG. 1D is a side view of the first embodiment with the universal lid installed thereon;

FIG. 2 is a side view of the second embodiment;

FIG. 2A is a top view of the second embodiment;

FIG. 2B is a side view of the second embodiment;

FIG. 2C is a top view of the second embodiment;

FIG. 2D is a side view of the second embodiment with the universal lid installed thereon;

FIG. 3 is a side view of the third embodiment;

FIG. 3A is a top view of the third embodiment;

FIG. 3B is a side view of the third embodiment;

FIG. 3C is a top view of the third embodiment;

FIG. 3D is a side view of the third embodiment with the universal lid installed thereon;

FIG. 4 is a side view of the universal lid;

FIG. 4A is a top view of the universal lid;

FIG. 4B is a side view of the universal lid;

FIG. 4C is a top view of the universal lid;

FIG. 4D is a side view of the third embodiment of the device with the universal lid installed thereon, and connected to the device with a hinge.

### DESCRIPTION OF EMBODIMENT OR EMBODIMENTS

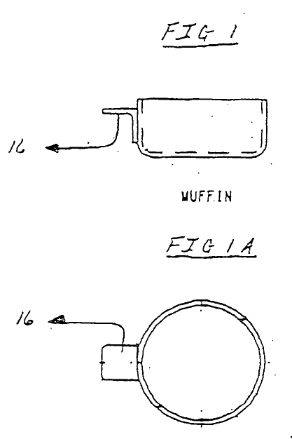

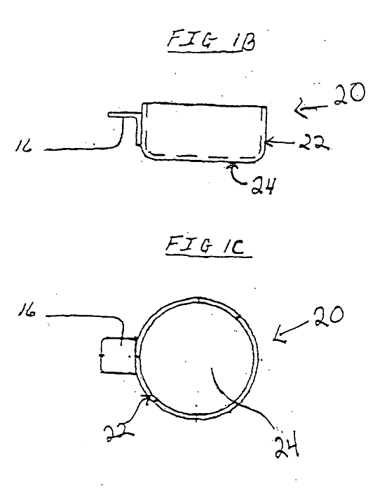

FIGS. 1 and 1B show a side view of the first embodiment 20. The handle 16 of the device is substantially L-shaped, and protrudes from the one side of the device 20. A handle 16 is disposed slightly lower than the top of the device 20, allowing for the universal lid 50 to be firmly secured in place with no obstruction. The handle 16 is long enough to prevent the user from burning his or her hands when removing the device 20 from the microwave. The embodiment is in the shape of a cylinder to match the shape of a typical English muffin sold in stores. From this view, it can be seen that the device is in cup- or bowl-like shape, and will hold the contents of the egg or egg mixture for cooking in the microwave. The device is comprised of a substantially circular base portion 24 and a substantially cylindrical wall portion 22. FIGS. 1A and 1C show a top view of the first embodiment 20. The handle 16 is seen protruding from one side of the device. The rim of the top of the substantially cylindrical wall 22 of the device is designed to receive the protrusion of the universal lid. FIG. 1D shows a side view of the first embodiment 20 with the universal lid installed thereon.

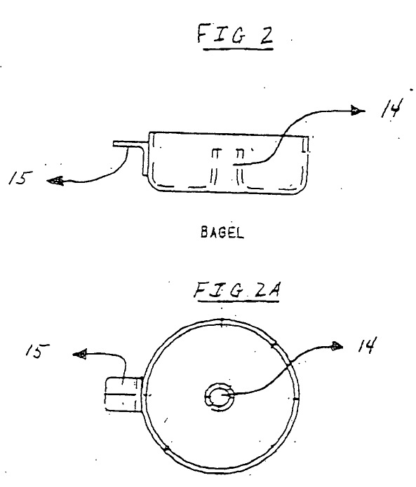

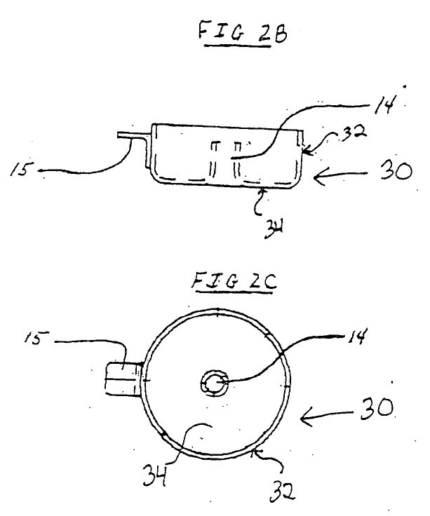

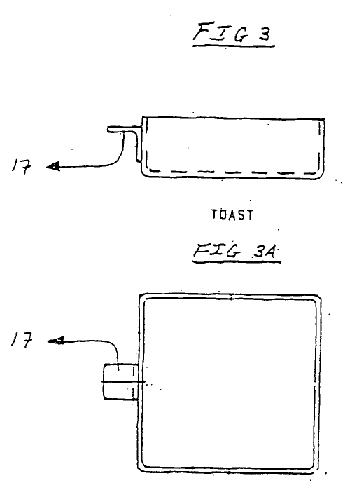

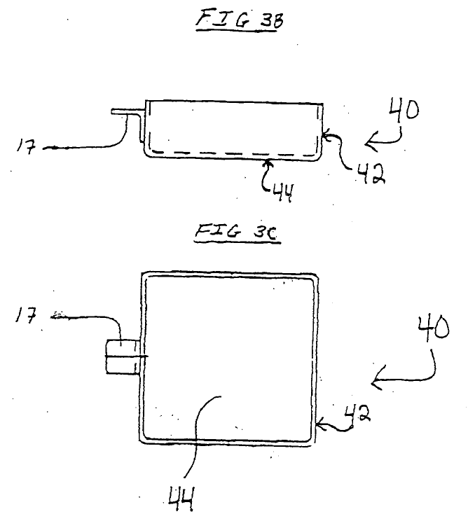

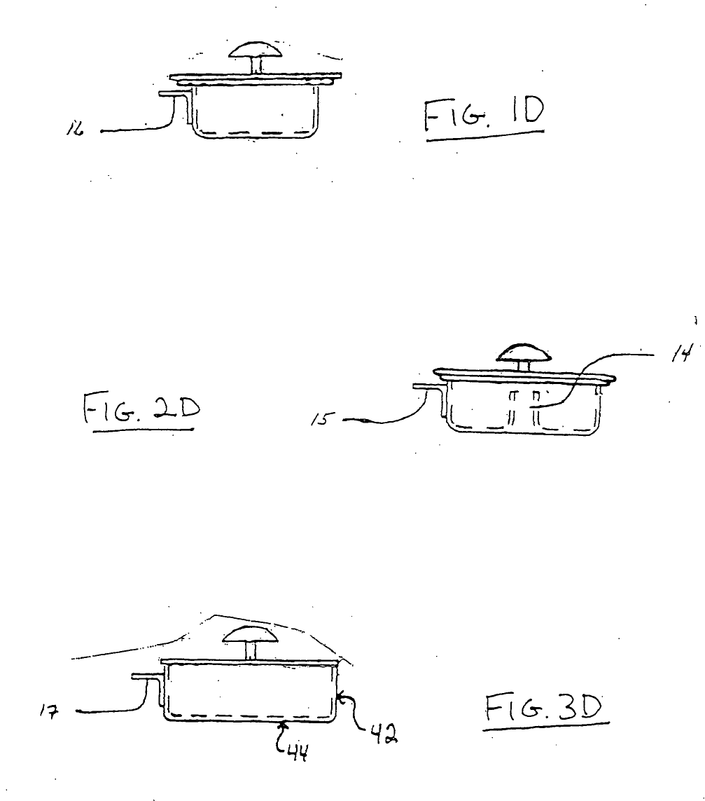

FIGS. 2 and 2B show a side view of the second embodiment 30. A handle 15 of the device 30 is substantially L-shaped, and protrudes from the one side of the device 30. The handle 15 is disposed slightly lower than the top of the device 30, allowing for the universal lid 50 to be firmly secured in place with no obstruction. The handle 15 is long enough to prevent the user from burning his or her hands when removing the device 30 from the microwave. This embodiment 30 is in the shape of a cylinder with a hole or void in the center, to match the shape of a typical bagel sold in stores. From this view, it can be seen that the device 30 is in cup- or bowl-like shape, and will hold the contents of the egg or egg mixture for cooking in the microwave. The device is comprised of a substantially circular base portion 34, a substantially cylindrical wall portion 32, and a cylindrical protrusion 14 for forming a hole in the egg to fit the shape of a bagel. The cylindrical protrusion 14 is disposed substantially at the center of the base portion 34 of the inside of the device 30, and stands substantially more than half as tall as the device 30. The cylindrical protrusion 14 does not stand as tall as the device 30 in order to permit the universal lid 50 to fit properly. FIGS. 2A and 2C show a top view of the second embodiment 30. The handle 15 can be seen protruding from the side of the device 30. The rim of the top of the wall portion 32 of the device 30 is designed to receive the protrusion of the universal lid 50. The cylindrical protrusion 14 is shown in the center of the device 30. FIG. 2D shows a side view of the second embodiment 30 with the universal lid installed thereon.

FIGS. 3 and 3B show a side view of the third embodiment 40. The handle 17 of the device 40 is substantially L-shaped, and protrudes from the one side of the device 40. A handle 17 is disposed slightly lower than the top of the device 40, allowing for the universal lid 50 to be firmly secured in place with no obstruction. The handle 17 is long enough to prevent the user from burning his or her hands when removing the device 40 from the microwave. This embodiment 40 is in the shape of a square to match the shape of a typical piece of bread sold in a loaf in stores. From this view, it can be seen that the device 40 is in cup- or bowl-like shape, and will hold the contents of the egg or egg mixture for cooking in the microwave. The device 40 is comprised of a substantially square base portion 44 and an essentially cubical wall portion 42. FIGS. 3A and 3C show a top view of the third embodiment 40. The handle 17 is seen protruding from one side of the device 40. The rim of the top of the essentially cubical wall 42 of the device 40 is designed to receive the protrusion of the universal lid 50. FIG. 3D shows a side view of the third embodiment 40 with the universal lid installed thereon.

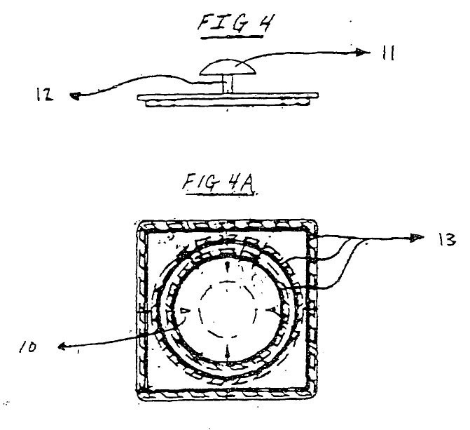

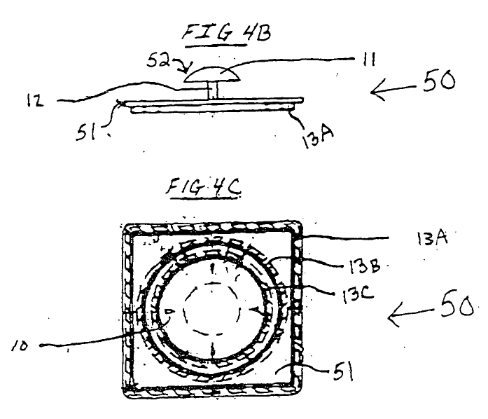

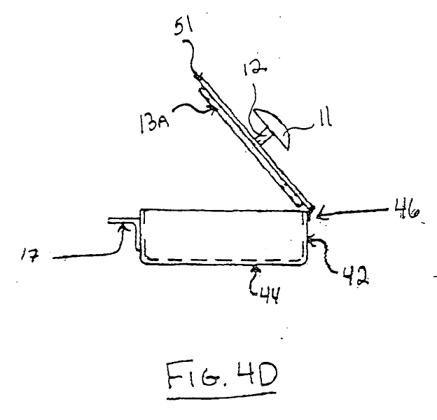

FIG. 4 shows a side view of the universal lid 50. The universal lid 50 comprises a protruding handle 52, which protruding handle 52 is comprised of a protruding portion 12 and a handle portion 11. The protruding handle 52 is disposed substantially at the center of the lid portion 51. A protruding rim portion 13A can be seen extending from the lid portion 51. FIG. 4A shows a top view of the universal lid 50. The universal lid 50 is substantially square-shaped to fit the embodiment 40 of the device designed to fit a square piece of bread. The edges of the universal lid 50 comprise a protruding lip 13A, which protruding lip 13A is designed to fit connectedly with the top of the device 40 for cooking eggs. The universal lid 50 further comprises a first circular protruding portion 13B and a second circular protruding portion 13C. The first circular protruding portion 13B is an appropriate size and circumference to fit connectedly with the top of the device 20 for cooking eggs in the shape of an English muffin. The second protruding portion 13C is an appropriate size to fit connectedly with the top of the device 30 for cooking eggs in the shape of a bagel. The protruding portions 13A, 13B, and 13C are designed not to interfere with the placement of either a smaller or larger device. The universal lid 50 further comprises a set of ventilation holes 10. The ventilation holes 10 are preferably disposed about the center of the lid portion 51, within the first protruding portion 13B and the second protruding portion 13C and around the protruding handle 52. In another possible embodiment, the ventilation holes 10 may be disposed anywhere else on the lid portion 51. FIG. 4D shows another possible embodiment of the device 40 with the universal lid 50 attached thereto with a hinge 46, and in a partially opened position.

FIG. 4 will include venting holes 10, four in all. In reference to FIG. 4, the universal lid has one handle comprising an egg shaped cap 11 extended from a ½″ post 12. This handle is used exclusively for placing and removing the universal lid. The formed lid will have no less than four punched or formed holes used for ventilation during the cooking process. The design of the lid includes three extrusions used to lock the lid into each device 13. The design permits the 0.18″ deep extrusions to slide into the inner diameter of each device. The extrusions are measured slightly less in size than the inner diameter of each device allowing the lid to slide down over each device. Each extrusion 13 is strategically formed as to not interfere with the placement of either a smaller FIG. 1 or a larger FIG. 3 device.

The lid is used during the cooking process as well as during the period the egg is cooling down.

Each device is formed to the shape of the desired bread such as the bagel FIG. 2, the squared loaf bread FIG. 3, and the muffin FIG. 1. The bagel device is cylindrically shaped and is formed with a circle shaped extrusion 14 placed directly in the center of the bagel device. The circle shaped extrusion 14 standing 1.12″ high forms the hole in the center of the egg as to mimic the shape of the bagel. This extrusion is hole in the center of the egg as to mimic the shape of the bagel. This extrusion is measured with enough diameter to create a hole that matches the common bagel. The bagel device FIG. 2 has an “L” shaped handle 15, which is formed slightly lower than the top of the device. This allows for the lid to be firmly secured in place with no obstruction. The muffin device FIG. 1 is also cylindrically shaped but smaller in diameter than the bagel FIG. 2. It also has a molded handle serving the same purpose as the bagel handle. The overall diameter of the muffin device is designed to match the diameter of most muffins on the market. The squared loaf shaped bread device FIG. 3 is molded in the form of a square to match the size of most square bread styles on the market. FIG. 3 has a handle molded on one side and is positioned slightly lower than the top of the device, 17.

The manner of using the universal lid FIGS. 4 and 4a with any of the devices is to begin by placing an uncooked shelled egg in the desired device placing the lid atop of the device placing the device with the lid securely fitted into the microwave oven and cooking the egg at the desired length of time. The device with the lid can be safely removed from the microwave by grasping the handle of the device and removing it from the microwave.

Please note that any measurements or dimensions described herein above are not meant to limit the invention in any way. Any number of measurements or dimensions may be applicable to different embodiments.

One feature or aspect of an embodiment is believed at the time of the filing of this patent application to possibly reside broadly in a device to cook an egg in the microwave, said device comprising: a device for holding eggs to be cooked in the microwave, said device comprising: a substantially cylindrical wall portion; a substantially circular base portion; and a handle, said handle being substantially L-shaped and being disposed about said wall portion and being disposed slightly lower than the top of said device for holding eggs to be cooked in the microwave; a universal lid, said universal lid comprising: a protruding handle comprising a protruding portion and a handle portion; a substantially square-shaped lid portion; a protruding lip portion disposed about the bottom of all four sides of said substantially square-shaped lid portion; a first circular protruding portion disposed about the bottom of said substantially square-shaped lid portion; a second circular protruding portion disposed about the bottom of said substantially square-shaped lid portion and within the center of said first circular protruding portion; and at least four ventilation holes disposed about said protruding handle of said substantially square-shaped lid portion.

Another feature or aspect of an embodiment is believed at the time of the filing of this patent application to possibly reside broadly in a device to cook an egg in the microwave, said device comprising: a device for holding eggs to be cooked in the microwave, said device comprising: a substantially cylindrical wall portion; a substantially circular base portion; a handle, said handle being substantially L-shaped and being disposed about said wall portion and being disposed slightly lower than the top of said device for holding eggs to be cooked in the microwave; and a substantially cylindrical protruding portion, said cylindrical protruding portion being disposed about the center of said device for holding eggs to be cooked in the microwave, and protruding up towards the top of the device, and not standing as tall as the device, permitting the universal lid to fit properly; a universal lid, said universal lid comprising: a protruding handle comprising a protruding portion and a handle portion; a substantially square-shaped lid portion; a protruding lip portion disposed about the bottom of all four sides of said substantially square-shaped lid portion; a first circular protruding portion disposed about the bottom of said substantially square-shaped lid portion; a second circular protruding portion disposed about the bottom of said substantially square-shaped lid portion and within the center of said first circular protruding portion; and at least four ventilation holes disposed about said protruding handle of said substantially square-shaped lid portion.

Yet another feature or aspect of an embodiment is believed at the time of the filing of this patent application to possibly reside broadly in a device to cook an egg in the microwave, said device comprising: a device for holding eggs to be cooked in the microwave, said device comprising: an essentially cubical wall portion; a substantially square-shaped base portion; and a handle, said handle being substantially L-shaped and being disposed about said wall portion and being disposed slightly lower than the top of said device for holding eggs to be cooked in the microwave; a universal lid, said universal lid comprising: a protruding handle comprising a protruding portion and a handle portion; a substantially square-shaped lid portion; a protruding lip portion disposed about the bottom of all four sides of said substantially square-shaped lid portion; a first circular protruding portion disposed about the bottom of said substantially square-shaped lid portion; a second circular protruding portion disposed about the bottom of said substantially square-shaped lid portion and within the center of said first circular protruding portion; and at least four ventilation holes disposed about said protruding handle of said substantially square-shaped lid portion.

Still another feature or aspect of an embodiment is believed at the time of the filing of this patent application to possibly reside broadly in a device to cook at least one egg in a microwave, said device comprising: an arrangement for holding at least one egg to be cooked in a microwave, said arrangement comprising: a substantially cylindrical wall portion; a base portion; said substantially cylindrical inner wall portion and said base portion being configured and disposed to be connected together to form a space to receive at least one egg to be cooked in the microwave, and to shape said at least one egg to form the shape of an English muffin; and a lid configured to be disposed atop said arrangement for receiving said at least one egg.

Another feature or aspect of an embodiment is believed at the time of the filing of this patent application to possibly reside broadly in a device to cook at least one egg in a microwave, said device comprising: an arrangement for holding at least one egg to be cooked in a microwave, said arrangement comprising: a substantially cylindrical inner wall portion; a base portion; a substantially cylindrical protruding portion, said cylindrical protruding portion being disposed substantially in the center of said arrangement for holding said at least one egg to be cooked in the microwave, and projecting up; said substantially cylindrical inner wall portion and said base portion being configured and disposed to be connected together to form a space to receive at least one egg to be cooked in the microwave, and to shape said at least one egg to form the shape of a bagel; and a lid configured to be disposed atop said arrangement for receiving said at least one egg.

Yet another feature or aspect of an embodiment is believed at the time of the filing of this patent application to possibly reside broadly in a device to cook at least one egg in a microwave, said device comprising: an arrangement for holding at least one egg to be cooked in a microwave, said arrangement comprising: a wall portion having substantially straight walls which are connected together to substantially form a rectangle; a substantially rectangular base portion; said wall portion having substantially straight walls which are connected together to substantially form a rectangle and said substantially rectangular base portion being configured and disposed to be connected together to form a space to receive at least one egg to be cooked in the microwave, and to shape said at least one egg to form the shape of a substantially square piece of bread; and a lid configured to be disposed atop said arrangement for receiving said at least one egg.

Still another feature or aspect of an embodiment is believed at the time of the filing of this patent application to possibly reside broadly in a device to cook at least one egg in a microwave, said device comprising: an arrangement for holding at least one egg to be cooked in a microwave, said arrangement comprising: a wall portion having substantially straight walls which are connected together to substantially form the shape of a slice of bread; a base portion which is substantially in the shape of a slice of bread; said wall portion having substantially straight walls which are connected together to substantially form the shape of a slice of bread and said base portion which is substantially in the shape of a slice of bread being configured and disposed to be connected together to form a space to receive at least one egg to be cooked in the microwave, and being designed to form a cooked egg being substantially formed to have the shape of a slice of bread and to conform to the slice of bread; and a lid configured to be disposed atop said arrangement for receiving said at least one egg.

Yet another feature or aspect of an embodiment is believed at the time of the filing of this patent application to possibly reside broadly in a device to cook at least one egg in a microwave, said device comprising: an arrangement for holding at least one egg to be cooked in a microwave, said arrangement comprising: an inner wall portion which forms the shape of a baked good; a base portion; said inner wall portion which forms the shape of a baked good and said base portion being configured and disposed to be connected together to form a space to receive at least one egg to be cooked in the microwave, and to shape said at least one egg to form the shape of a baked good; and a lid configured to be disposed atop said arrangement for receiving said at least one egg.

A further feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical wall portion; a base portion; said substantially cylindrical inner wall portion and said base portion being configured and disposed to be connected together to form a space to receive at least one egg to be cooked in the microwave, and to shape said at least one egg to form the shape of an English muffin; and a lid configured to be disposed atop said arrangement for receiving said at least one egg; said method comprising the steps of: preparing the at least one egg; placing the at least one egg into the device; placing said lid atop the egg cooking device; setting the microwave to the desired power and time for cooking; cooking the egg in the microwave for the desired time at the desired power setting; removing the device from the microwave once the desired time has expired; removing the lid; and placing the egg on the English muffin.

Another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical inner wall portion; a base portion; a substantially cylindrical protruding portion, said cylindrical protruding portion being disposed substantially in the center of said arrangement for holding said at least one egg to be cooked in the microwave, and projecting up; said substantially cylindrical inner wall portion and said base portion being configured and disposed to be connected together to form a space to receive at least one egg to be cooked in the microwave, and to shape said at least one egg to form the shape of a bagel; and a lid configured to be disposed atop said arrangement for receiving said at least one egg; said method comprising the steps of: preparing the at least one egg; placing the at least one egg into the device; placing said lid atop the egg cooking device; setting the microwave to the desired power and time for cooking; cooking the egg in the microwave for the desired time at the desired power setting; removing the device from the microwave once the desired time has expired; removing the lid; and placing the egg on the bagel.

Still another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a wall portion having substantially straight walls which are connected together to substantially form a rectangle; a substantially rectangular base portion; said wall portion having substantially straight walls which are connected together to substantially form a rectangle and said substantially rectangular base portion being configured and disposed to be connected together to form a space to receive at least one egg to be cooked in the microwave, and to shape said at least one egg to form the shape of a substantially square piece of bread; and a lid configured to be disposed atop said arrangement for receiving said at least one egg; said method comprising the steps of: preparing the at least one egg; placing the at least one egg into the device; placing said lid atop the egg cooking device; setting the microwave to the desired power and time for cooking; cooking the egg in the microwave for the desired time at the desired power setting; removing the device from the microwave once the desired time has expired; removing the lid; and placing the egg on the slice of bread.

Still another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: an inner wall portion which forms the shape of a baked good; a base portion; said inner wall portion which forms the shape of a baked good and said base portion being configured and disposed to be connected together to form a space to receive at least one egg to be cooked in the microwave, and to shape said at least one egg to form the shape of a baked good; and a lid configured to be disposed atop said arrangement for receiving said at least one egg; said method comprising the steps of: preparing the at least one egg; placing the at least one egg into the device; placing said lid atop the egg cooking device; setting the microwave to the desired power and time for cooking; cooking the egg in the microwave for the desired time at the desired power setting; removing the device from the microwave once the desired time has expired; removing the lid; and placing the egg on the baked good.

Yet another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical wall portion; a base portion; said substantially cylindrical inner wall portion and said base portion being configured and disposed to be connected together to form a space to receive at least one egg to be cooked in the microwave, and to shape said at least one egg to form the shape of an English muffin; said method comprising the steps of: preparing the at least one egg; placing the at least one egg into the device; placing a cover atop the egg cooking device; setting the microwave to the desired power and time for cooking; cooking the egg in the microwave for the desired time at the desired power setting; removing the device from the microwave once the desired time has expired; removing the cover from atop the device; and placing the egg on the English muffin.

A further feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical inner wall portion; a base portion; a substantially cylindrical protruding portion, said cylindrical protruding portion being disposed substantially in the center of said arrangement for holding said at least one egg to be cooked in the microwave, and projecting up; said substantially cylindrical inner wall portion and said base portion being configured and disposed to be connected together to form a space to receive at least one egg to be cooked in the microwave, and to shape said at least one egg to form the shape of a bagel; said method comprising the steps of: preparing the at least one egg; placing the at least one egg into the device; placing a cover atop the egg cooking device; setting the microwave to the desired power and time for cooking; cooking the egg in the microwave for the desired time at the desired power setting; removing the device from the microwave once the desired time has expired; removing the cover from atop said device; and placing the egg on the bagel.

Another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a wall portion having substantially straight walls which are connected together to substantially form a rectangle; a substantially rectangular base portion; said wall portion having substantially straight walls which are connected together to substantially form a rectangle and said substantially rectangular base portion being configured and disposed to be connected together to form a space to receive at least one egg to be cooked in the microwave, and to shape said at least one egg to form the shape of a substantially square piece of bread; said method comprising the steps of: preparing the at least one egg; placing the at least one egg into the device; placing a cover atop the egg cooking device; setting the microwave to the desired power and time for cooking; cooking the egg in the microwave for the desired time at the desired power setting; removing the device from the microwave once the desired time has expired; removing the cover from atop said device; and placing the egg on the slice of bread.

Still another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical wall portion; a base portion; said substantially cylindrical inner wall portion and said base portion being configured and disposed to be connected together to form a space to receive at least one egg to be cooked in the microwave, and to shape said at least one egg to form the shape of an English muffin; said method comprising the steps of: preparing the at least one egg; placing the at least one egg into the device; setting the microwave to the desired power and time for cooking; cooking the egg in the microwave for the desired time at the desired power setting; removing the device from the microwave once the desired time has expired; and placing the egg on the English muffin.

Yet another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical inner wall portion; a base portion; a substantially cylindrical protruding portion, said cylindrical protruding portion being disposed substantially in the center of said arrangement for holding said at least one egg to be cooked in the microwave, and projecting up; said substantially cylindrical inner wall portion and said base portion being configured and disposed to be connected together to form a space to receive at least one egg to be cooked in the microwave, and to shape said at least one egg to form the shape of a bagel; said method comprising the steps of: preparing the at least one egg; placing the at least one egg into the device; setting the microwave to the desired power and time for cooking; cooking the egg in the microwave for the desired time at the desired power setting; removing the device from the microwave once the desired time has expired; and placing the egg on the bagel.

A further feature or aspect of an embodiment is believed at the time of the filing of this patent application to possibly reside broadly in a method of preparing an egg using A device to cook at least one egg in a microwave, said device comprising: an arrangement for holding at least one egg to be cooked in a microwave, said arrangement comprising: a wall portion having substantially straight walls which are connected together to substantially form a rectangle; a substantially rectangular base portion; said wall portion having substantially straight walls which are connected together to substantially form a rectangle and said substantially rectangular base portion being configured and disposed to be connected together to form a space to receive at least one egg to be cooked in the microwave, and to shape said at least one egg to form the shape of a substantially square piece of bread; said method comprising the steps of: preparing the at least one egg; placing the at least one egg into the device; setting the microwave to the desired power and time for cooking; cooking the egg in the microwave for the desired time at the desired power setting; removing the device from the microwave once the desired time has expired; and placing the egg on the slice of bread.

A further feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical wall portion; a base portion; said substantially cylindrical inner wall portion and said base portion being configured and disposed to be connected together to form a space to receive at least one egg to be cooked in the microwave, and to shape said at least one egg to form the shape of an English muffin; said method comprising the steps of: preparing the at least one egg; placing the at least one egg into the device; covering the egg cooking device; setting the microwave to the desired power and time for cooking; cooking the egg in the microwave for the desired time at the desired power setting; removing the device from the microwave once the desired time has expired; removing the covering from atop the device; and placing the egg on the English muffin.

Another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a substantially cylindrical inner wall portion; a base portion; a substantially cylindrical protruding portion, said cylindrical protruding portion being disposed substantially in the center of said arrangement for holding said at least one egg to be cooked in the microwave, and projecting up; said substantially cylindrical inner wall portion and said base portion being configured and disposed to be connected together to form a space to receive at least one egg to be cooked in the microwave, and to shape said at least one egg to form the egg to fit on the bagel and to leave the hole of the bagel uncovered; said method comprising the steps of: preparing the at least one egg; placing the at least one egg into the device; covering the egg cooking device; setting the microwave to the desired power and time for cooking; cooking the egg in the microwave for the desired time at the desired power setting; removing the device from the microwave once the desired time has expired; removing the covering from atop said device; and placing the egg on the bagel.

Yet another feature or aspect of an embodiment is believed at the time of the filing of this patent application to possibly reside broadly in a method of preparing an egg using a device to cook at least one egg in a microwave, said device comprising: an arrangement for holding at least one egg to be cooked in a microwave, said arrangement comprising: a wall portion having substantially straight walls which are connected together to substantially form a rectangle; a substantially rectangular base portion; said wall portion having substantially straight walls which are connected together to substantially form a rectangle and said substantially rectangular base portion being configured and disposed to be connected together to form a space to receive at least one egg to be cooked in the microwave, and to shape said at least one egg to form the shape of a substantially square piece of bread; said method comprising the steps of: preparing the at least one egg; placing the at least one egg into the device; covering the egg cooking device; setting the microwave to the desired power and time for cooking; cooking the egg in the microwave for the desired time at the desired power setting; removing the device from the microwave once the desired time has expired; removing the covering from atop said device; and placing the egg on the slice of bread.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Some examples of microwavable containers or microwavable materials which may be utilized or adapted for use in at least one possible embodiment may possibly be found in the following U.S. patents: U.S. Pat. No. 6,097,017, entitled “Microwave oven food container;” U.S. Pat. No. 5,876,811, entitled “Microwavable single-serving meal container;” U.S. Pat. No. 5,607,709, entitled “Disposable microwavable food container;” U.S. Pat. No. 4,505,962, entitled “Microwavable plastic containers with heat and grease resistant layer comprising impact polymer;” U.S. Pat. No. 6,320,172, entitled “Microwavable container for food products and method of fabricating same;” U.S. Pat. No. 6,251,451, entitled “Microwavable package;” and U.S. Pat. No. 4,341,872, entitled “Microwave-compatible nepheline glass-ceramics.”

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

1-24. (canceled)

25. A device to cook an egg in the microwave, said device comprising:
a device for holding eggs to be cooked in the microwave, said device comprising:
a substantially cylindrical wall portion;
a substantially circular base portion; and
a handle, said handle being substantially L-shaped and being disposed about said wall portion and being disposed slightly lower than the top of said device for holding eggs to be cooked in the microwave;
a universal lid, said universal lid comprising:
a protruding handle comprising a protruding portion and a handle portion;
a substantially square-shaped lid portion;
a protruding lip portion disposed about the bottom of all four sides of said substantially square-shaped lid portion;
a first circular protruding portion disposed about the bottom of said substantially square-shaped lid portion;
a second circular protruding portion disposed about the bottom of said substantially square-shaped lid portion and within the center of said first circular protruding portion; and
at least four ventilation holes disposed about said protruding handle of said substantially square-shaped lid portion.

26. The device to cook an egg in the microwave according to claim 25, wherein said universal lid is hingedly attached to said substantially cylindrical wall portion.

27. The device to cook an egg in the microwave according to claim 26, wherein said device for holding eggs is shaped to prepare eggs in substantially the shape of at least one of:
an English muffin;
a bagel;
a sandwich roll; and
a croissant.

28. The device to cook an egg in the microwave according to claim 27, wherein said device for holding eggs is constructed with a plastic material.

29. The device to cook an egg in the microwave according to claim 28, wherein said universal lid comprises a plurality of extrusions configured to lock said universal lid onto said substantially cylindrical wall portion during cooking.

30. The device to cook an egg in the microwave according to claim 25, wherein said device for holding eggs comprises a substantially cubical wall portion being configured to prepare an egg for substantially square-shaped bread.

31. A device to cook at least one egg in a microwave, said device comprising:
an arrangement for holding at least one egg to be cooked in a microwave, said arrangement comprising:
an inner wall portion which forms the shape of a baked good;
a base portion;
said inner wall portion which forms the shape of a baked good and said base portion being configured and disposed to be connected together to form a space to receive at least one egg to be cooked in the microwave, and to shape said at least one egg to form the shape of a baked good; and
a lid configured to be disposed atop said arrangement for receiving said at least one egg.

32. The device to cook at least one egg in the microwave according to claim 31, wherein said lid is hingedly attached to said inner wall portion.

33. The device to cook at least one egg in the microwave according to claim 32, wherein said arrangement for holding at least one egg is shaped to prepare eggs in substantially the shape of at least one of:
an English muffin;
a bagel;
a sandwich roll; and
a croissant.

34. The device to cook at least one egg in the microwave according to claim 33, wherein said arrangement for holding at least one egg is constructed with a plastic material.

35. The device to cook at least one egg in the microwave according to claim 34, wherein said lid comprises a plurality of extrusions configured to lock said lid onto said inner wall portion during cooking.

36. The device to cook at least one egg in the microwave according to claim 35, wherein said arrangement for holding at least one egg comprises a substantially cubical inner wall portion being configured to prepare an egg for substantially square-shaped bread.

37. The device to cook at least one egg in the microwave according to claim 36, wherein said lid comprises ventilation holes.

38. A method of preparing an egg using a device to cook at least one egg in a microwave, said device comprising: an arrangement for holding at least one egg to be cooked in a microwave, said arrangement comprising: an inner wall portion which forms the shape of a baked good; a base portion; said inner wall portion which forms the shape of a baked good and said base portion being configured and disposed to be connected together to form a space to receive at least one egg to be cooked in the microwave, and to shape said at least one egg to form the shape of a baked good; and a lid configured to be disposed atop said arrangement for receiving said at least one egg; said method comprising the steps of:
preparing the at least one egg;
placing the at least one egg into the device;
covering the egg cooking device;
setting the microwave to the desired power and time for cooking;
cooking the egg in the microwave for the desired time at the desired power setting;
removing the device from the microwave once the desired time has expired;
removing the covering from atop said device; and
placing the egg on the baked good.

39. The method of preparing an egg according to claim 38, wherein said lid is hingedly attached to said inner wall portion.

40. The method of preparing an egg according to claim 39, wherein said arrangement for holding at least one egg is shaped to prepare eggs in substantially the shape of at least one of:
an English muffin;
a bagel;
a sandwich roll; and
a croissant.

41. The method of preparing an egg according to claim 40, wherein said arrangement for holding at least one egg is constructed with a plastic material.

42. The method of preparing an egg according to claim 41, wherein said lid comprises a plurality of extrusions configured to lock said lid onto said inner wall portion during cooking.

43. The method of preparing an egg according to claim 42, wherein said arrangement for holding at least one egg comprises a substantially cubical inner wall portion being configured to prepare an egg for substantially square-shaped bread.

44. The method of preparing an egg according to claim 43, wherein said lid comprises ventilation holes.
